(19) United States
(12) Patent Application Publication
(10) Pub. No.: US 2022/0137203 A1
(43) Pub. Date: May 5, 2022

(54) TRAJECTORY IDENTIFICATION APPARATUS, METHOD, AND NON-TRANSITORY TANGIBLE MACHINE-READABLE MEDIUM THEREOF

(71) Applicant: Institute For Information Industry, Taipei (TW)

(72) Inventors: Chia-Hsin CHAN, Taipei (TW); Wen-Kai LIU, Taipei (TW)

(21) Appl. No.: 17/112,785

(22) Filed: Dec. 4, 2020

(30) Foreign Application Priority Data
Nov. 5, 2020 (TW) 109138697

(51) Int. Cl. G01S 13/58

(52) U.S. Cl. CPC G01S 13/589; G01S 13/931; G01S 13/588

(57) ABSTRACT

A trajectory identification apparatus, method, and computer program product thereof are provided. The apparatus converts the object positions into a two-dimensional space to generate and sequence a plurality of object coordinates, calculates a distance of adjacent object coordinates to generate a trajectory-time image. The apparatus calculates a sum-distance, and calculates an initial speed based on a first distance and the sum-distance to generate a trajectory-speed image. The apparatus separates the trajectory-time image into a first channelizing datum, separates trajectory-speed image into a second channelizing datum, and overlaps the first channelizing datum and the second channelizing datum to generate a to-be detected channelizing datum. The apparatus inputs the to-be detected channelizing datum into an identification model to generate a prospective channelizing datum, compares the degree of difference between the to-be detected channelizing datum and the prospective channelizing datum to generate a trajectory identification result.

### PRIORITY

This application claims priority to Taiwan Patent Application No. 109138697 filed on Nov. 5, 2020, which is hereby incorporated by reference in its entirety.

### FIELD

The present invention relates to a trajectory identification apparatus, method, and non-transitory tangible machine-readable medium thereof. Specifically, the present invention relates to a trajectory identification apparatus, method, and non-transitory tangible machine-readable medium thereof that combine trajectory time and trajectory speed.

### BACKGROUND

With the rapid development of technology and transportation industry, the demand for automatic identification technology in transportation field is increasing. Presently, some practices in the industry use machine learning technology for automatic trajectory identification, but these practices have to integrate a large amount of trajectory information in order to accurately identify abnormal trajectories. Although an identification technology that integrates a large amount of trajectory information into a “single image” is already available, such an identification technology can only identify changes in the position and speed of an object, but cannot obtain the actual speed of the object. Therefore, the aforementioned identification technology cannot identify all kinds of trajectory information of the object simply via a “single image”.

Accordingly, there is an urgent need for a technique that can integrate a large amount of trajectory information and simultaneously identify multiple kinds of trajectory information of objects so as to provide a more diversified automatic identification service.

### SUMMARY

An objective of certain embodiments of the present invention is to provide a trajectory identification apparatus. The trajectory identification apparatus may comprise a storage and a processor, wherein the processor is electrically connected with the storage. The storage is configured to store an identification model and a to-be-identified trajectory datum, wherein the to-be-identified trajectory datum comprises a plurality of object positions, and the object positions correspond to a plurality of time one-to-one. The processor converts the object positions into a two-dimensional space to generate and sort a plurality of object coordinates, and calculates a distance between adjacent ones among the object coordinates to generate a trajectory-time image. The processor calculates a total distance according to the distances, and calculates an initial speed according to a first distance of the distances and the total distance to generate a trajectory-speed image. The processor separates the trajectory-time image into a first channelizing datum, separates the trajectory-speed image into a second channelizing datum, and overlaps the first channelizing datum and the second channelizing datum to generate a to-be-identified channelizing datum. The processor inputs the to-be-identified channelizing datum into the identification model to obtain a prospective channelizing datum, and generates a trajectory identification result by comparing a degree of difference between the to-be-identified channelizing datum and the prospective channelizing datum.

An objective of certain embodiments of the present invention is to provide a trajectory identification method. The trajectory identification method is adapted for use in an electronic computing apparatus. The electronic computing apparatus is configured to store an identification model and a to-be-identified trajectory datum, wherein the to-be-identified trajectory datum comprises a plurality of object positions, and the object positions correspond to a plurality of time one-to-one. The trajectory identification method comprises the following steps: (a) converting the object positions into a two-dimensional space to generate and sort a plurality of object coordinates; (b) calculating a distance between adjacent ones among the object coordinates to generate a trajectory-time image; (c) calculating a total distance according to the distances; (d) calculating an initial speed according to a first distance of the distances and the total distance to generate a trajectory-speed image; (e) separating the trajectory-time image into a first channelizing datum; (f) separating the trajectory-speed image into a second channelizing datum; (g) overlapping the first channelizing datum and the second channelizing datum to generate a to-be-identified channelizing datum; (h) inputting the to-be-identified channelizing datum into the identification model to obtain a prospective channelizing datum; and (i) generating a trajectory identification result by comparing a degree of difference between the to-be-identified channelizing datum and the prospective channelizing datum.

An objective of certain embodiments of the present invention is to provide a non-transitory tangible machine-readable medium, which stores a computer program comprising a plurality of codes. After the computer program is loaded into an electronic computing apparatus, are executed by the electronic computing apparatus to implement a trajectory identification method. The electronic computing apparatus is configured to store an identification model and a to-be-identified trajectory datum, wherein the to-be-identified trajectory datum comprises a plurality of object positions, the object positions correspond to a plurality of time one-to-one, and the trajectory identification method comprises the following steps: converting the object positions into a two-dimensional space to generate and sort a plurality of object coordinates; calculating a distance between adjacent ones among the object coordinates to generate a trajectory-time image; calculating a total distance according to the distances; calculating an initial speed according to a first distance of the distances and the total distance to generate a trajectory-speed image; separating the trajectory-time image into a first channelizing datum; separating the trajectory-speed image into a second channelizing datum; overlapping the first channelizing datum and the second channelizing datum to generate a to-be-identified channelizing datum; inputting the to-be-identified channelizing datum into the identification model to obtain a prospective channelizing datum; and generating a trajectory identification result by comparing a degree of difference between the to-be-identified channelizing datum and the prospective channelizing datum.

According to the above description, the trajectory identification technology provided by the present invention (including the apparatus, method, and non-transitory tangible machine-readable medium thereof) generates and sorts a plurality of object coordinates by converting a plurality of object positions of a to-be-identified trajectory datum of an object into a two-dimensional space. The trajectory identification technology provided by the present invention calculates a trajectory-time image (i.e., the change in speed of the object at each time) according to the distance between the adjacent ones among the object coordinates, and calculates a total distance according to the distances, and then calculates an initial speed according to a first distance of the distances and the total distance to generate a trajectory-speed image (i.e., the initial speed of the object in the trajectory). In addition, the trajectory identification technology provided by the present invention may further separate the trajectory-time image into a first channelizing datum, separate the trajectory-speed image into a second channelizing datum, and overlap the first channelizing datum and the second channelizing datum to generate a to-be-identified channelizing datum. The trajectory identification technology provided by the present invention may further input the to-be-identified channelizing datum into an identification model to obtain a prospective channelizing datum, and generate a trajectory identification result by comparing a degree of difference between the input (the to-be-identified channelizing datum) and the output (the prospective channelizing datum) of the identification model.

Accordingly, the present invention may describe the change in speed of the object at each time in the trajectory-time image, describe the initial speed of the object in the trajectory in the trajectory-speed image, and integrate them into the input information of the identification model. Through the aforesaid operations/steps, the present invention can integrate a large amount of trajectory information, and simultaneously identify multiple kinds of trajectory information of the object so as to provide a more diversified automatic identification service.

What described above are not intended to limit the present invention, but only generally describe the technical problems that can be solved by the present invention, the technical means that can be adopted by the present invention, and the technical effects that can be achieved by the present invention so that those of ordinary skill in the art can preliminarily understand the present invention. The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a trajectory identification apparatus 1 of a first embodiment;

FIG. 2A is a specific example of a trajectory-time image of the present invention;

FIG. 2B is another specific example of the trajectory-time image of the present invention;

FIG. 3A is a specific example of a trajectory-speed image of the present invention;

FIG. 3B is a another specific example of the trajectory-speed image of the present invention;

FIG. 4 is depicting how the trajectory identification apparatus 1 overlaps the first channelizing datum and the second channelizing datum; and

FIG. 5 is a flowchart depicting a second embodiment.

### DETAILED DESCRIPTION

In the following description, a trajectory identification apparatus, method, and non-transitory tangible machine-readable medium thereof will be explained with reference to example embodiments thereof. However, these example embodiments are not intended to limit the present invention to any specific environment, applications, or particular implementations described in these example embodiments. Therefore, description of these example embodiments is only for the purpose of illustration rather than to limit the scope of the present invention.

It shall be appreciated that, in the following embodiments and the attached drawings, elements unrelated to the present invention are omitted from depiction, Furthermore, dimensions of elements and dimensional proportions between individual elements in the attached drawings are provided only for ease of depiction and illustration, but not to limit the scope of the present invention.

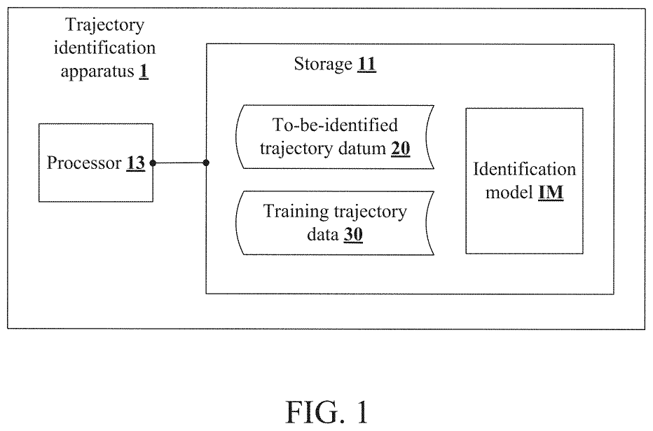

A first embodiment of the present invention is a trajectory identification apparatus 1, whose schematic view is depicted in FIG. 1. The trajectory identification apparatus 1 comprises a storage 11 and a processor 13, wherein the storage 11 and the processor 13 are electrically connected with each other. The storage 11 may be a memory, a universal serial bus (USB), a hard disk, a compact disk (CD), a digital versatile disc (DVD), a mobile disk, or any other non-transitory storage medium or storage circuits that are capable of storing digital data and well-known to those of ordinary skill in the art. The processor 13 may be one of various processors, central processing units (CPUs), microprocessor units (MPUs), digital signal processors (DSPs), or other computing apparatuses well-known to those of ordinary skill in the art.

In this embodiment, the storage 11 of the trajectory identification apparatus 1 may be used to store a to-be-identified trajectory datum 20. The to-be-identified trajectory datum 20 comprises a plurality of object positions (not shown), and the object positions correspond to a plurality of time one-to-one. It shall be noted that, the to-be-identified trajectory datum 20 refers to various trajectory data of an object (such as an automobile, a motorcycle, a bicycle, etc.) moving or traveling for a period of time (for example, 0 to 3 seconds), wherein the object positions refer to the actual position reached by the object moving at each time.

The to-be-identified trajectory datum 20 may be stored in the storage 11 in advance, or may be obtained by an external apparatus. If the to-be-identified trajectory datum 20 is obtained by an external apparatus, the trajectory identification apparatus 1 may further comprise an input interface (not shown), wherein the input interface is used to receive the to-be-identified trajectory datum 20 from a sensor (not shown). For example, the sensor comprises a radar sensor (not shown), which detects the driving trajectory of vehicles on a road section at a fixed time interval (for example, every 0.5 seconds, every 1 second). For another example, the input interface of the trajectory identification apparatus 1 may receive the to-be-identified trajectory datum 20 from an image camera (not shown), and the image camera takes photos of the driving trajectory of vehicles on a road section at a frequency of a fixed number of frames per second (for example, 12 frames per second and 24 frames per second). In some embodiments, the input interface may also receive the to-be-identified trajectory datum 20 by other detection methods (such as GPS, manual marking, etc.).

The storage 11 of the trajectory identification apparatus 1 may be used to store an identification model IM, and the identification model IM may be obtained after being pre-trained by an external apparatus or may be obtained after being trained by the trajectory identification apparatus 1 itself. If the identification model IM is trained by the trajectory identification apparatus 1 itself, the storage 11 may additionally store a plurality of training trajectory data 30, and the processor 13 utilizes the training trajectory data 30 to train the identification model IM.

The identification model IM may be a machine learning model trained by various known unsupervised machine learning techniques. For example, in some embodiments, the identification model IM may comprise an auto-encoder (AE), and the training trajectory data 30 may comprise various normal trajectory information (e.g., not exceeding the legal speed limit, not driving off the road, etc.). The auto-encoder may comprise an encoder and a decoder, and the encoder encodes the training trajectory data 30, converts the input to generate a latent-space representation, and then the decoder decodes the latent-space representation to generate output data of a specific format, and the processor 13 uses the output data to train the identification model IM. The processor 13 may repeat the above training process until the identification model IM outputs the same or similar data as the training trajectory data 30. It shall be noted that, how to train a machine learning model shall be well-known to those of ordinary skill in the art, and thus will not be further described herein.

Related operations of the trajectory identification apparatus 1 to generate a trajectory identification result by using the identification model IM and the to-be-identified datum 20 will now be described. Specifically, in this embodiment, the processor 13 may convert the to-be-identified datum 20 into a two-dimensional space. In this case, the two-dimensional space will generate a plurality of object coordinates corresponding to the object positions, and the processor 13 may sort the object coordinates according to the time.

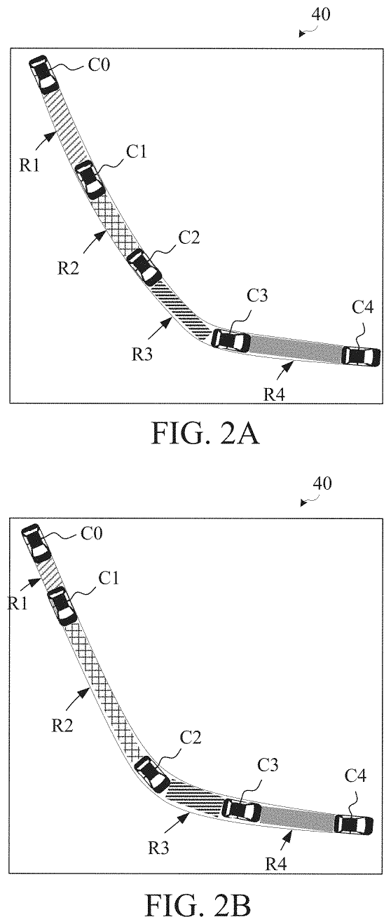

Next, detailed operations of the trajectory identification apparatus 1 to generate a trajectory-time image 40 will be exemplified with reference to FIG. 2A to FIG. 2B. It shall be noted that, the contents shown in FIG. 2A to FIG. 2B are only for illustrating the embodiments of the present invention, but not for limiting the scope of the present invention.

In this embodiment, when the processor 13 converts the object positions into a two-dimensional space, a moving or traveling trajectory may be displayed in the two-dimensional space, the processor 13 first calculates a distance between any two adjacent object coordinates on the trajectory, and then describes the change in speed of the object between every two time according to the sequence of the object coordinates. Specifically, the trajectory is generated when the object moves or travels for a period of time (i.e., 0 to 4 seconds), wherein the trajectory comprises a plurality of object coordinates (i.e., C0, C1, C2, C3 and C4). The object coordinate C0 represents that the object appears for the first time (i.e., at 0^{th} second), the object coordinate C1 represents that the object appears at a first time (i.e., the 1^{st} second), and similarly, the object coordinate C4 represents that the object appears at a fourth time (i.e., the 4^{th} second), and this will not be further described herein. The processor 13 may calculate the distance between any two adjacent object coordinates (that is, the distance for which the object moves at each time) according to each of the object coordinates C0, C1, C2, C3 and C4 so as to identify a plurality of trajectory sections.

For comprehension of understanding, please refer to the specific examples shown in FIG. 2A to FIG. 2B together. The processor 13 may mark the trajectory section R1 as oblique lines, mark the trajectory section R2 as grids, mark the trajectory section R3 as thick oblique lines, and mark the trajectory section R4 as gray scales according to each of the distances. Through this description, the change in speed of the object at each time may be presented. In other words, the processor 13 may mark each of the trajectory sections differently according to the above actions to describe the acceleration value of the object at each time. However, it shall be appreciated that, the way in which each of the distances is marked is not limited in the present invention.

In some embodiments, the processor 13 sequentially marks each of the aforesaid trajectory sections with a plurality of colors. For example, the processor 13 may calculate a proportion of each trajectory section on the trajectory according to the following Equation 1, and determine the colors represented by the object coordinates according to the proportion. However, it shall be appreciated that, the Equation 1 is not intended to limit the scope of the present invention:

$$Hue ( x ι , y ι ) = \frac{ι}{T} \qquad ( Equation 1 )$$

wherein, Hue represents hue (e.g., red, orange, yellow, green or the like), ι represents each time, and T represents a total time. Please noted that if the trajectory identification apparatus 1 obtains the to-be-identified datum 20 via the image camera, then ι represents the image number (for example, the first frame, the second frame, etc.) at each time when the image camera captures the to-be-identified datum 20. It is noted that, the hue may be divided into 0 degrees to 360 degrees, and different angles represent different colors (for example, 0 degrees is red, 30 degrees is orange, 60 degrees is yellow, and 90 degrees is green, etc.). How to convert colors into hue angles shall be well-known to those of ordinary skill in the art, and thus will not be further described herein.

The processor 13 may repeat the above Equation 1 until the proportion of each trajectory section on the trajectory is calculated, and the processor 13 determines a hue angle corresponding to the trajectory section according to each of the proportions, and uses the color represented by the hue angle as the color of each trajectory section. For example, the processor 13 may determine that R1 is red, R2 is orange, R3 is yellow and R4 is green according to the hue angles corresponding to the proportions, and mark R1 as red (corresponding to the oblique lines shown in FIG. 2A to FIG. 2B), mark R2 as orange (corresponding to the grids shown in FIG. 2A to FIG. 2B), mark R3 as yellow (corresponding to the thick oblique lines shown in FIG. 2A to FIG. 2B) and mark R4 as green (corresponding to the gray scales shown in FIG. 2A to FIG. 2B). Therefore, the distance for which the object moves at each time may be identified by the color marked for each trajectory section. However, it shall be appreciated that, the color of each trajectory section is not limited in the present invention.

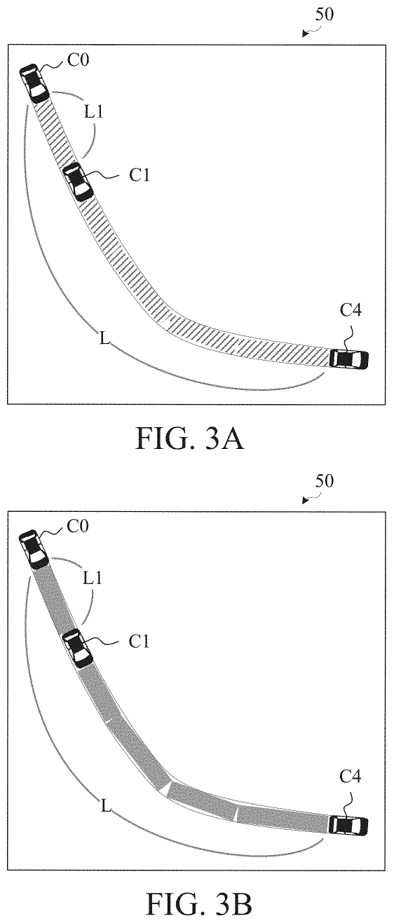

Next, the detailed operation of generating the trajectory-speed image 50 by the trajectory identification apparatus 1 will be exemplified. Please refer to the specific examples shown in FIG. 3A and FIG. 3B together. In this embodiment, the processor 13 calculates a total distance L (i.e., a distance from the object coordinate C0 to the object coordinate C4) according to the distances, and then calculates an initial speed according to a first distance L1 (i.e., the distance from the object coordinate C0 to the object coordinate C1) and the total distance L, and the initial speed may represent the actual speed (e.g., 20 km/h) of the object from the object coordinate C0 to the object coordinate C4. Further speaking, the processor 13 may mark the trajectory according to the initial speed to generate a trajectory-speed image 50. Through this description, the actual speed of the object from the object coordinate C0 to the object coordinate C4 may be presented. The processor 13 may mark the trajectory differently according to the above actions to describe the initial speed of the object. However, it shall be appreciated that, the way in which the initial speed is marked is not limited in the present invention.

As shown in FIG. 3A, the processor 13 may calculates the initial speed of the object according to the above operation, and if the initial speed is 20 km/h, the processor 13 marks the trajectory as oblique lines. As shown in FIG. 3B, the processor 13 may calculate the initial speed of the object according to the above operation, and if the initial speed is 100 km/h, then the processor 13 marks the trajectory as gray scales.

In some embodiments, the processor 13 marks the initial speed with a color. Specifically, the processor 13 may calculate the initial speed and determine the color represented by the initial speed according to the following Equation 2. However, it shall be appreciated that, the Equation 2 is not intended to limit the scope of the present invention:

$$Hue ( x ι , y ι ) = \frac{dist \{ ( x ι , y ι ) ( x ι - 1 , y ι - 1 ) \}}{L} \qquad ( Equation 2 )$$

wherein, Hue represents hue (e.g., red, green or the like), ι represents each time, and L represents a total distance (i.e., the distance from the object coordinate C0 to the object coordinate C4). It is noted that, the processor 13 may calculate an initial speed according to the above Equation 2, determine a hue angle corresponding to the initial speed, and take the color represented by the hue angle as the color of the trajectory. For example, if the initial speed is 20 km/h, the processor 13 determines that the speed is red (corresponding to the oblique lines shown in FIG. 3A) according to the hue angle corresponding to the initial speed, and marks the trajectory as red. For another example, if the initial speed is 100 km/h, the processor 13 determines that the speed is green (corresponding to the gray scales shown in FIG. 3B) according to the hue angle corresponding to the initial speed, and marks the trajectory as green. Therefore, the initial speed of the object may be identified by the color marked for the trajectory. However, it shall be appreciated that, the colors represented by various initial speeds are not limited by the present invention.

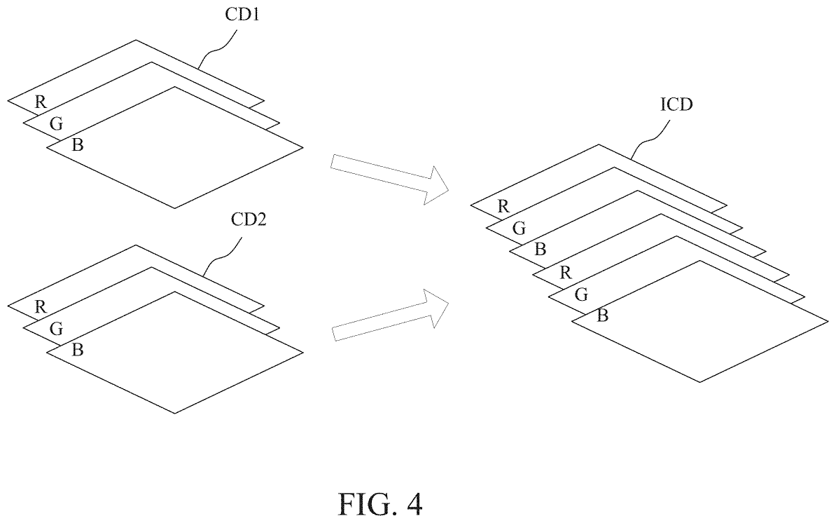

Through the above operation, the processor 13 generates the trajectory-time image 40 and the trajectory-speed image 50. Then, the processor separates the trajectory-time image 40 and the trajectory-speed image 50 into channelizing (RGB-channel) data and overlaps them, so as to combine the trajectory information contained in the trajectory-time image 40 and the trajectory-speed image 50. In this embodiment, the processor 13 separates the trajectory-time image 40 into a first channelizing datum CD1 (e.g., m×n×3 channelizing datum), separates the trajectory-speed image 50 into a second channelizing datum CD2 (e.g., m×n×3 channelizing datum), and overlaps the first channelizing datum and the second channelizing datum to generate a to-be-identified channelizing datum ICD (e.g., m×n×6 channelizing datum), as shown in FIG. 4. How to separate an image into channelizing data and overlap a plurality of channelizing data shall be appreciated by those of ordinary skill in the art, and thus will not be further described herein.

Then, the processor 13 inputs the to-be-identified channelizing datum ICD into the identification model IM, and the identification model IM outputs a prospective channelizing datum (not shown). Please noted that, the identification model IM outputs the same or similar data as the training trajectory data 30, so the prospective channelizing datum may represent the normal trajectory information. It shall be noted that, the to-be-identified channelizing datum ICD and the prospective channelizing datum have the same specific format (i.e., both of which are channelizing data). Further speaking, the processor 13 may generate a trajectory identification result by comparing a degree of difference between the to-be-identified channelizing datum ICD and the prospective channelizing datum. In other words, the processor 13 may determine the difference between the to-be-identified channelizing datum ICD and the prospective channelizing datum, and if the difference therebetween is too high, the trajectory identification result is confirmed as abnormal. On the contrary, if the processor 13 determines that the difference between the to-be-identified channelizing datum ICD and the prospective channelizing datum is not high, then the trajectory identification result is confirmed as normal.

In some embodiments, the processor 13 may generate the trajectory identification result by various known detectors. For example, the processor 13 may determine a difference value by comparing the to-be-identified channelizing datum ICD with the prospective channelizing datum by an anomaly detector, and generate the trajectory identification result by comparing the difference value with an anomaly threshold value. It shall be noted that, the anomaly threshold value may be set according to the training trajectory data 30.

In some embodiments, the loss function of the anomaly detector may further be expressed by a Binary Cross Entropy (BCE) and a Kullback-Leibler Divergence (KLD). For example, for the to-be-identified channelizing datum ICD and the prospective channelizing datum, the processor 13 may calculate a first difference value based on the Binary Cross Entropy, calculate a second difference value based on the Kullback-Leibler Divergence, and then determine whether the sum of the first difference value and the second difference value is greater than the anomaly threshold value, and if the sum of the first difference value and the second difference value is greater than the anomaly threshold value, the trajectory identification result is confirmed as abnormal. On the contrary, if the sum of the first difference value and the second difference value is less than the anomaly threshold value, then the trajectory identification result is confirmed as normal.

In some embodiments, the anomaly detector may further select other loss functions, and the loss function selected by the anomaly detector is not limited by the present invention. Please noted that, how to determine the difference by the anomaly detector shall be well-known to those of ordinary skill in the art, and thus will not be further described herein.

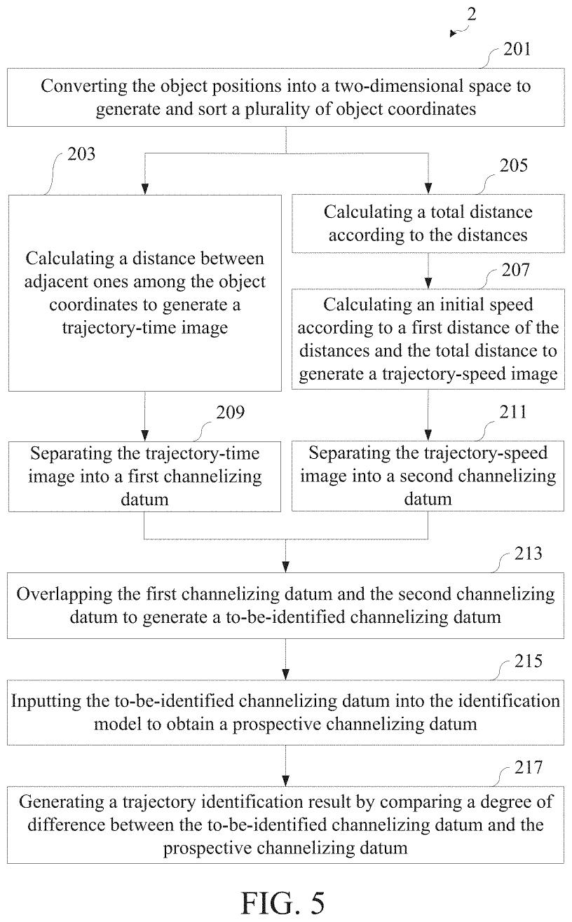

A second embodiment of the present invention is a trajectory identification method, and a main flowchart diagram thereof is depicted in FIG. 5. The content shown in FIG. 5 is only for exemplifying the embodiment of the present invention, and is not intended to limit the scope claimed in the present invention.

In this embodiment, the trajectory identification method is adapted for use in an electronic computing apparatus, e.g., the trajectory identification apparatus 1 in the first embodiment. The electronic computing apparatus stores an identification model and a to-be-identified trajectory datum, wherein the to-be-identified trajectory datum comprises a plurality of object positions, and the object positions correspond to a plurality of time in one-to-one correspondence. The trajectory identification method may comprise the following steps: converting the object positions into a two-dimensional space to generate and sort a plurality of object coordinates (labeled as step 201); calculating a distance between adjacent ones among the object coordinates to generate a trajectory-time image (labeled as step 203); calculating a total distance according to the distances (labeled as step 205); calculating an initial speed according to a first distance of the distances and the total distance to generate a trajectory-speed image (labeled as step 207); separating the trajectory-time image into a first channelizing datum (labeled as step 209); separating the trajectory-speed image into a second channelizing datum (labeled as step 211); overlapping the first channelizing datum and the second channelizing datum to generate a to-be-identified channelizing datum (labeled as step 213); inputting the to-be-identified channelizing datum into the identification model to obtain a prospective channelizing datum (labeled as step 215); and generating a trajectory identification result by comparing a difference between the to-be-identified channelizing datum and the prospective channelizing datum (labeled as 217).

The order of steps shown in FIG. 5 is not limited, and the order of the steps shown may be arbitrarily adjusted while it is implementable. For example, in some embodiments, the steps 201 to 217 may be performed in sequence. In some embodiments, the step 201, step 203, step 209, step 205, step 207, step 211, step 213, step 215 and step 217 may be performed in sequence. In some embodiments, the step 203 and the step 205 may be performed simultaneously. In some embodiments, the step 209 and the step 211 may be performed simultaneously.

In some embodiments, the electronic computing apparatus further stores a plurality of training trajectory data, and the trajectory identification method further comprises the following step: training the identification model according to the training trajectory data.

In some embodiments, the step 203 may mark the trajectory-time image with a plurality of colors according to each of the distances.

In some embodiments, the step 207 may mark the trajectory-speed image with a color according to the initial speed.

In some embodiments, the identification model is an auto-encoder.

In some embodiments, the trajectory identification method further comprises the following step: receiving the to-be-identified trajectory datum from a sensor.

In some embodiments, the trajectory identification method further comprises the following step: receiving the to-be-identified trajectory datum from a sensor. In addition, the sensor comprises a radar sensor.

In some embodiments, the step 217 may execute the following steps by an anomaly detector: comparing the to-be-identified channelizing datum with the prospective channelizing datum to determine a difference value; and generating the trajectory identification result by comparing the difference value with an anomaly threshold value.

In some embodiments, the loss function of the anomaly detector is based on a Binary Cross Entropy (BCE) and a Kullback-Leibler Divergence (KLD).

All of the above embodiments of the trajectory identification method may be executed by the trajectory identification apparatus 1. In addition, each embodiment of the trajectory identification method corresponds to at least one embodiment described above for the trajectory identification apparatus 1. Therefore, all the corresponding embodiments of the trajectory identification method as well as how to perform the above operations and steps, have the same functions and achieve the same technical effects based on the trajectory identification apparatus 1 shall be readily appreciated by those of ordinary skill in the art according to the above description of the trajectory identification apparatus 1, and thus will not be further described herein.

The trajectory identification method described in the second embodiment of the present invention as a computer program comprising a plurality of codes. The computer program is stored in non-transitory tangible machine-readable medium. The non-transitory computer readable storage medium may be an electronic product, e.g., a read only memory (ROM), a flash memory, a floppy disk, a hard disk, a compact disk (CD), a digital versatile disc (DVD), a mobile disk, or any other storage medium with the same function and well-known to those of ordinary skill in the art. After the codes of the computer program are loaded into an electronic computing apparatus (e.g., the trajectory identification apparatus 1), the electronic computing apparatus executes the trajectory identification method as described in the second embodiment.

It is noted that, in the specification and the claims of the present invention, some terms (e.g., distance, time and difference value, etc.) are preceded by terms such as “first” or “second”, and these terms of “first” or “second” are only used to distinguish that these terms refer to different items.

According to the above descriptions, the trajectory identification technology provided by the present invention (including the apparatus, method, and non-transitory tangible machine-readable medium thereof) generates and sorts a plurality of object coordinates by converting a plurality of object positions of a to-be-identified trajectory datum of an object into a two-dimensional space. The trajectory identification technology provided by the present invention calculates a trajectory-time image (i.e., the change in speed of the object at each time) according to the distance between the adjacent ones among the object coordinates, and calculates a total distance according to the distances, and then calculates an initial speed according to a first distance of the distances and the total distance to generate a trajectory-speed image (i.e., the initial speed of the object in the trajectory). In addition, the trajectory identification technology provided by the present invention may further separate the trajectory-time image into a first channelizing datum, separate the trajectory-speed image into a second channelizing datum, and overlap the first channelizing datum and the second channelizing datum to generate a to-be-identified channelizing datum.

The trajectory identification technology provided by the present invention may further input the to-be-identified channelizing datum into an identification model to obtain a prospective channelizing datum, and generate a trajectory identification result by comparing a difference between the input (the to-be-identified channelizing datum) and the output (the prospective channelizing datum) of the identification model. Accordingly, the trajectory identification technology provided by the present invention may describe the change in speed of the object at each time in the trajectory-time image, describe the initial speed of the object in the trajectory in the trajectory-speed image, and integrate them into the input information of the identification model. Through the aforesaid operations/steps, the trajectory identification technology provided by the present invention can integrate a large amount of trajectory information, and simultaneously identify multiple kinds of trajectory information of the object so as to provide a more diversified automatic identification service.

The above disclosure is only utilized to enumerate some embodiments of the present invention and illustrated technical features thereof, which is not used to limit the scope of the present invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A trajectory identification apparatus, comprising:
a storage, being configured to store an identification model and a to-be-identified trajectory datum, wherein the to-be-identified trajectory datum comprises a plurality of object positions, and the object positions correspond to a plurality of time one-to-one; and
a processor, being electrically connected with the storage, and being configured to convert the object positions into a two-dimensional space to generate and sort a plurality of object coordinates, and calculate a distance between adjacent ones among the object coordinates to generate a trajectory-time image;
wherein the processor calculates a total distance according to the distances, and calculates an initial speed value according to a first distance of the distances and the total distance to generate a trajectory-speed image;
wherein the processor further separates the trajectory-time image into a first channelizing datum, separates the trajectory-speed image into a second channelizing datum, and overlaps the first channelizing datum and the second channelizing datum to generate a to-be-identified channelizing datum;
wherein the processor further inputs the to-be-identified channelizing datum into the identification model to obtain a prospective channelizing datum, and generates a trajectory identification result by comparing a degree of difference between the to-be-identified channelizing datum and the prospective channelizing datum.

2. The trajectory identification apparatus of claim 1, wherein:
the storage is further configured to store a plurality of training trajectory data; and
the processor further trains the identification model according to the training trajectory data.

3. The trajectory identification apparatus of claim 1, wherein the processor marks the trajectory-time image with a plurality of colors according to each of the distances.

4. The trajectory identification apparatus of claim 1, wherein the processor marks the trajectory-speed image with a color according to the initial speed.

5. The trajectory identification apparatus of claim 1, wherein the identification model is an auto-encoder (AE).

6. The trajectory identification apparatus of claim 1, further comprising an input interface, wherein the input interface is configured to receive the to-be-identified trajectory datum from a sensor.

7. The trajectory identification apparatus of claim 6, wherein the sensor comprises a radar sensor.

8. The trajectory identification apparatus of claim 1, wherein the processor generates the trajectory identification result by performing the following operations by an anomaly detector:
comparing the to-be-identified channelizing datum with the prospective channelizing datum to determine a difference value; and
generating the trajectory identification result by comparing the difference value with an anomaly threshold value.

9. The trajectory identification apparatus of claim 8, wherein the processor calculates the difference value based on a Binary Cross Entropy (BCE) and a Kullback-Leibler Divergence (KLD).

10. A trajectory identification method, being adapted for use in an electronic computing apparatus, the electronic computing apparatus being configured to store an identification model and a to-be-identified trajectory datum, wherein the to-be-identified trajectory datum comprises a plurality of object positions, the object positions correspond to a plurality of time one-to-one, the trajectory identification method comprising:
(a) converting the object positions into a two-dimensional space to generate and sort a plurality of object coordinates;
(b) calculating a distance between adjacent ones among the object coordinates to generate a trajectory-time image;
(c) calculating a total distance according to the distances;
(d) calculating an initial speed according to a first distance of the distances and the total distance to generate a trajectory-speed image;
(e) separating the trajectory-time image into a first channelizing datum;
(f) separating the trajectory-speed image into a second channelizing datum;
(g) overlapping the first channelizing datum and the second channelizing datum to generate a to-be-identified channelizing datum;
(h) inputting the to-be-identified channelizing datum into the identification model to obtain a prospective channelizing datum; and
(i) generating a trajectory identification result by comparing a degree of difference between the to-be-identified channelizing datum and the prospective channelizing datum.

11. The trajectory identification method of claim 10, wherein the electronic computing apparatus further stores a plurality of training trajectory data, the trajectory identification method further comprising:
training the identification model according to the training trajectory data.

12. The trajectory identification method of claim 10, wherein the step (b) further marks the trajectory-time image with a plurality of colors according to each of the distances.

13. The trajectory identification method of claim 10, wherein the step (d) further marks the trajectory-speed image with a color according to the initial speed.

14. The trajectory identification method of claim 10, wherein the identification model is an auto-encoder (AE).

15. The trajectory identification method of claim 10, further comprising:
receiving the to-be-identified trajectory datum from a sensor.

16. The trajectory identification method of claim 15, wherein the sensor comprises a radar sensor.

17. The trajectory identification method of claim 10, wherein the step (i) executes the following steps by an anomaly detector, comprising:
comparing the to-be-identified channelizing datum with the prospective channelizing datum to determine a difference value; and
generating the trajectory identification result by comparing the difference value with an anomaly threshold value.

18. The trajectory identification method of claim 17, wherein the difference value is calculated based on a Binary Cross Entropy (BCE) and a Kullback-Leibler Divergence (KLD).

19. A non-transitory tangible machine-readable medium storing a computer program comprising a plurality of codes, an electronic computing apparatus executing the codes to perform a data interpretation method after the computer program being loaded into an electronic computing apparatus, are executed by the electronic computing apparatus to implement a trajectory identification method, the electronic computing apparatus being configured to store an identification model and a to-be-identified trajectory datum, wherein the to-be-identified trajectory datum comprises a plurality of object positions, the object positions correspond to a plurality of time one-to-one, the trajectory identification method comprising:
converting the object positions into a two-dimensional space to generate and sort a plurality of object coordinates;
calculating a distance between adjacent ones among the object coordinates to generate a trajectory-time image;
calculating a total distance according to the distances;
calculating an initial speed according to a first distance of the distances and the total distance to generate a trajectory-speed image;
separating the trajectory-time image into a first channelizing datum;
separating the trajectory-speed image into a second channelizing datum;
overlapping the first channelizing datum and the second channelizing datum to generate a to-be-identified channelizing datum;
inputting the to-be-identified channelizing datum into the identification model to obtain a prospective channelizing datum; and
generating a trajectory identification result by comparing a degree of difference between the to-be-identified channelizing datum and the prospective channelizing datum.
